(19) United States
(12) Patent Application Publication
(10) Pub. No.: US 2004/0238573 A1
(43) Pub. Date: Dec. 2, 2004

(54) Dispenser head for a fluid product dispenser

(76) Inventor: Alexandra Parmentier, Rouen (FR)

Correspondence Address: SUGHRUE MION, PLLC, 2100 PENNSYLVANIA AVENUE, N.W., SUITE 800, WASHINGTON, DC, 20037, US

(21) Appl. No.: 10/487,037

(22) PCT Filed: Aug. 22, 2002
(86) PCT No.: PCT/FR02/02927

(30) Foreign Application Priority Data
Aug. 23, 2001 (FR) 01/11049

(51) Int. Cl. G01F 11/06

(52) U.S. Cl. 222/321.1

(57) ABSTRACT

A dispenser head for a fluid dispenser, the dispenser head being provided with a dispensing orifice (21; 121) which opens out to the outside at a free front surface (22; 122); said dispenser head being characterized in that it is also provided with trim (3) which extends over a portion of the free front surface and which is provided with fixing means (331; 332; 333; 334) for fixing it to the head.

The present invention relates to a dispenser head, such as a pump or a valve, for a fluid dispenser. This type of dispenser is often used in the fields of perfumes, cosmetics, or indeed pharmaceuticals, for dispensing a fluid from a reservoir which is often in the form of a flask. In general, the pump or the valve includes a movable actuator member or pusher. The dispenser head can be integrated directly into the pusher, but, in certain cases, the dispenser head can be independent from the pusher: the dispenser can then be referred to as a “fixed spray” dispenser. Therefore, in the present invention, the expression “dispenser head” can designate a pusher incorporating a dispensing orifice or some other part of the pump or of the valve that incorporates the dispensing orifice. The term “dispensing orifice” is used to designate a final outlet opening via which the fluid exits from the dispenser. Beyond the orifice, the fluid is in the form of an optionally sprayed stream, a drop, or a trickle depending on the type of fluid (lotion, perfume, cream, gel, etc.), and on the desired dispensing.

In general, the dispenser head forms a free front surface at which the dispensing orifice opens out to the outside. The free front surface is the visible surface of the head that extends around the dispensing orifice. The fluid dispensed may be in the form of a stream of sprayed droplets, or else in the form of a metered quantity or “dose” of semi-liquid fluid which is dispensed on and collected from said free front surface.

Since the free front surface is fully visible to the user of the dispenser and since it constitutes a portion of the dispenser that the user tends to notice easily because the fluid dispensed is delivered thereat, it is advantageous for said surface to have an attractive appearance. An object of the present invention is thus to improve the attractiveness of the free front surface of a dispenser head.

To this end, the present invention proposes for the dispenser head to be further provided with trim which extends over a portion of the free front surface and which is provided with fixing means for fixing it to the head. The finishing touch of attractiveness is thus brought by the trim which masks partially and attractively a portion of the free front surface, while naturally leaving the dispensing orifice unobstructed. The trim constitutes a sort of accessory for the dispenser head that makes said head easy to customize in an attractive manner, as a function of the type of fluid or of the brand of the fluid. The trim does not form or even complete the dispensing orifice: it does not play any functional part in dispensing the fluid. The dispensing orifice by itself performs final dispensing of the fluid in the form of a stream, spray, trickle, drop, etc.

In an ordinary embodiment, the dispenser head comprises a body forming a fluid outlet duct opening out into a recess, and a dispenser element forming the dispensing orifice and disposed in the recess in the body so that the outlet duct communicates with the dispensing orifice. Advantageously, the dispenser element projects from the recess so that its free front surface is offset forwards relative to the body, the fixing means for fixing the trim co-operating with a peripheral surface of the dispenser element, which surface extends around the free front surface. In a variant, the dispenser element is pushed into the recess so that its free front surface is situated inside the recess, the fixing means for fixing the trim co-operating with an inside wall of the recess. In another variant, an annular groove is defined between the dispenser element and an inside wall of the recess, the fixing means of the trim being inserted into said groove. Alternatively, the fixing means for fixing the trim extend around the body.

It is also possible for the body and the dispenser element to be formed in one piece with each other.

In another embodiment, the dispenser head may comprise a body forming the dispensing orifice, said trim extending around said body at least in part. The trim can then be in the form of a ring fitted around the body of the head. At the dispensing orifice, the trim forms an opening that masks, at least partially, the free front surface in which the dispensing orifice is provided.

Advantageously, the trim remains out of contact with the fluid dispensed through the dispensing orifice.

Advantageously, the trim extends around the dispensing orifice at least in part.

The invention is described more fully below with reference to the accompanying drawings which show embodiments of the invention by way of non-limiting example.

In the figures:

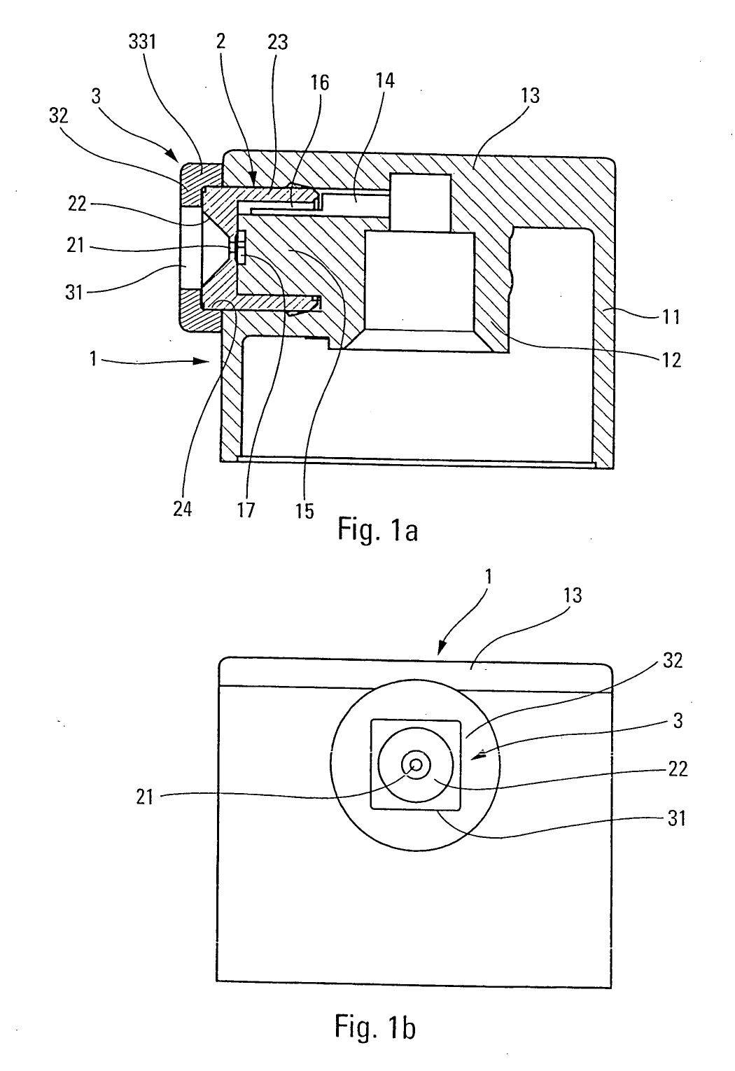

FIGS. 1a and 1b are respectively a vertical cross-section view and a front view of a first embodiment of a dispenser head of the invention;

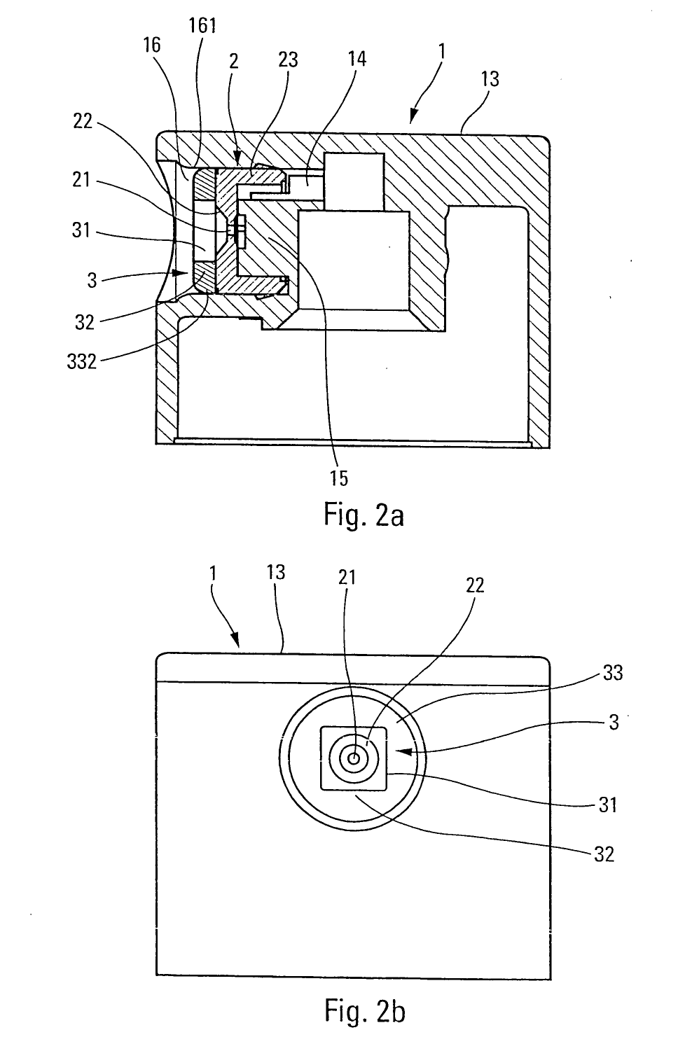

FIGS. 2a and 2b are views similar to the views of FIGS. 1a and 1b for a second embodiment of a dispenser head of the invention;

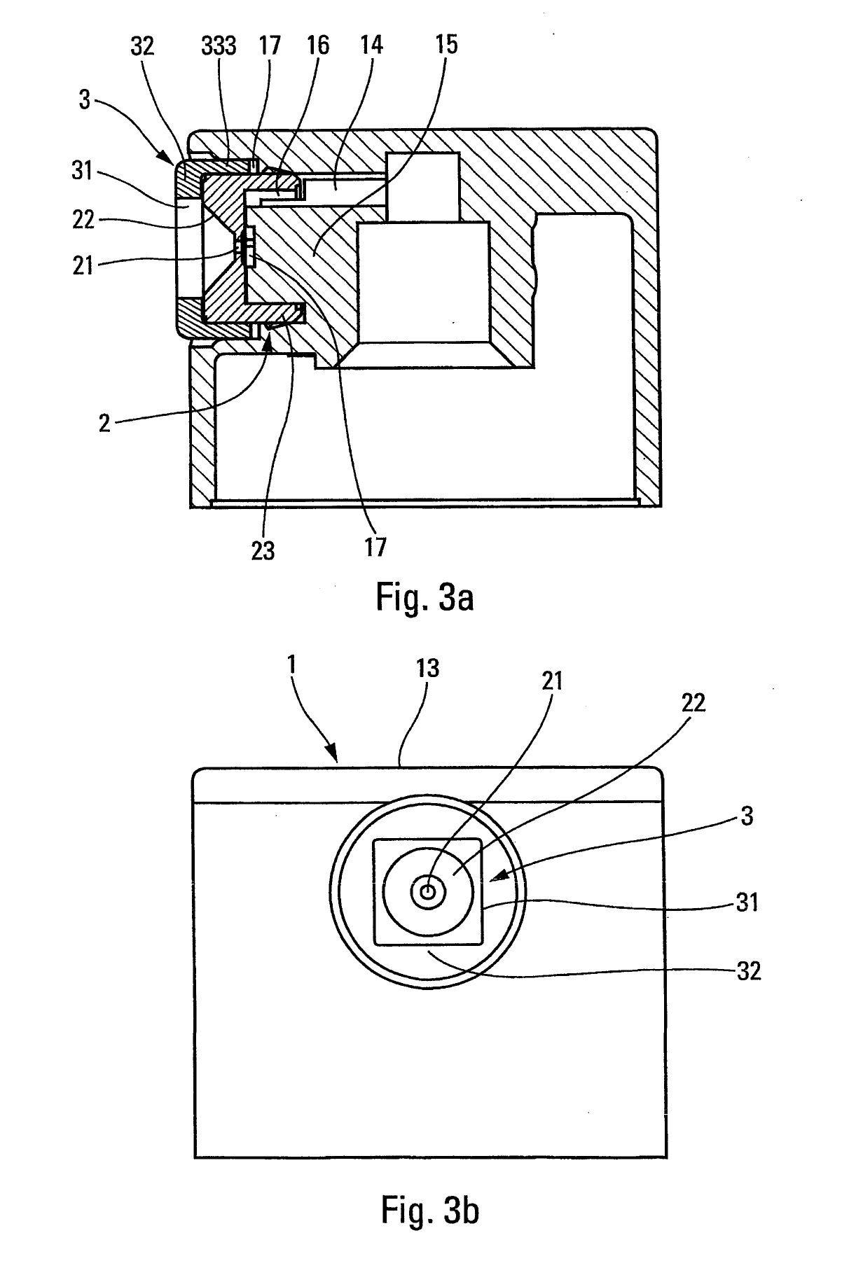

FIGS. 3a and 3b are views similar to the preceding views for a third embodiment of the invention;

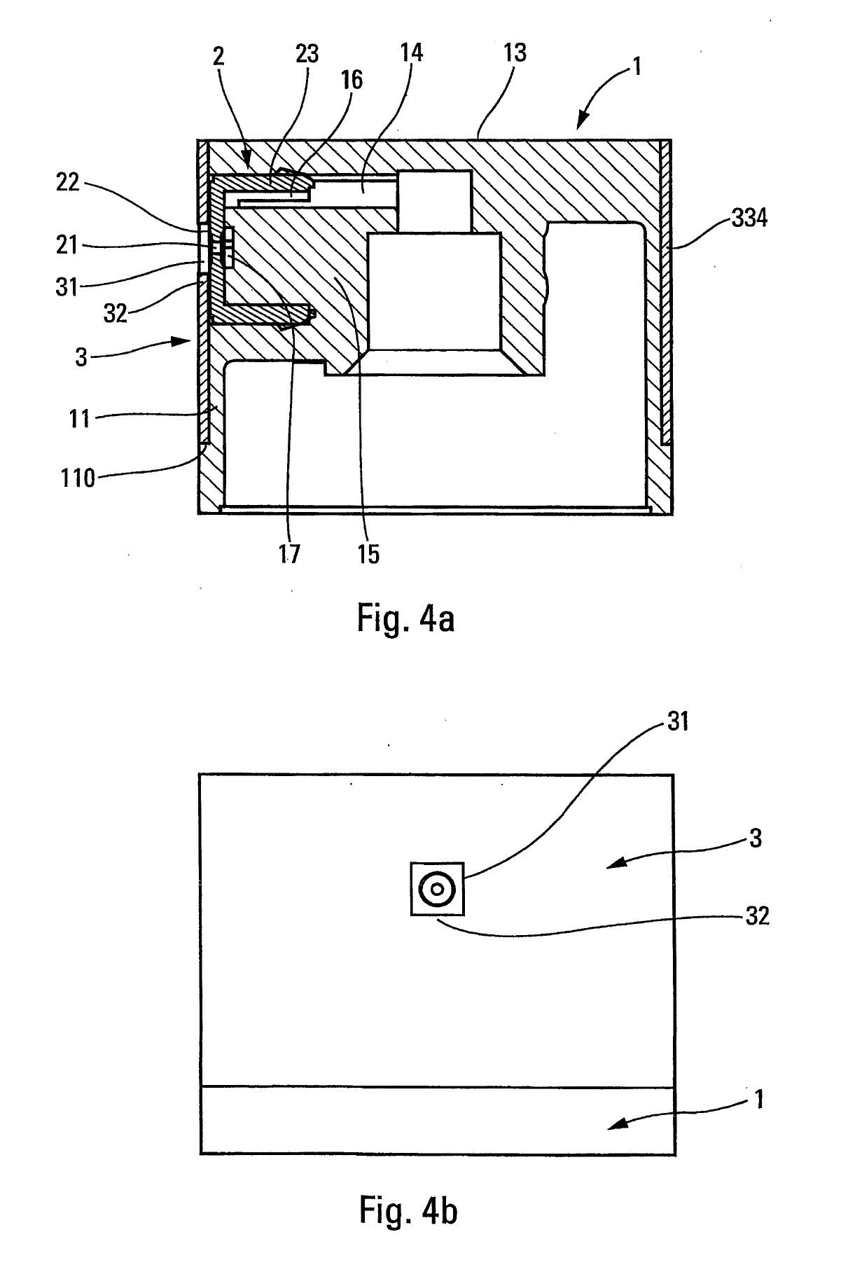

FIGS. 4a and 4b are views similar to the preceding figures for a fourth embodiment of the invention; and

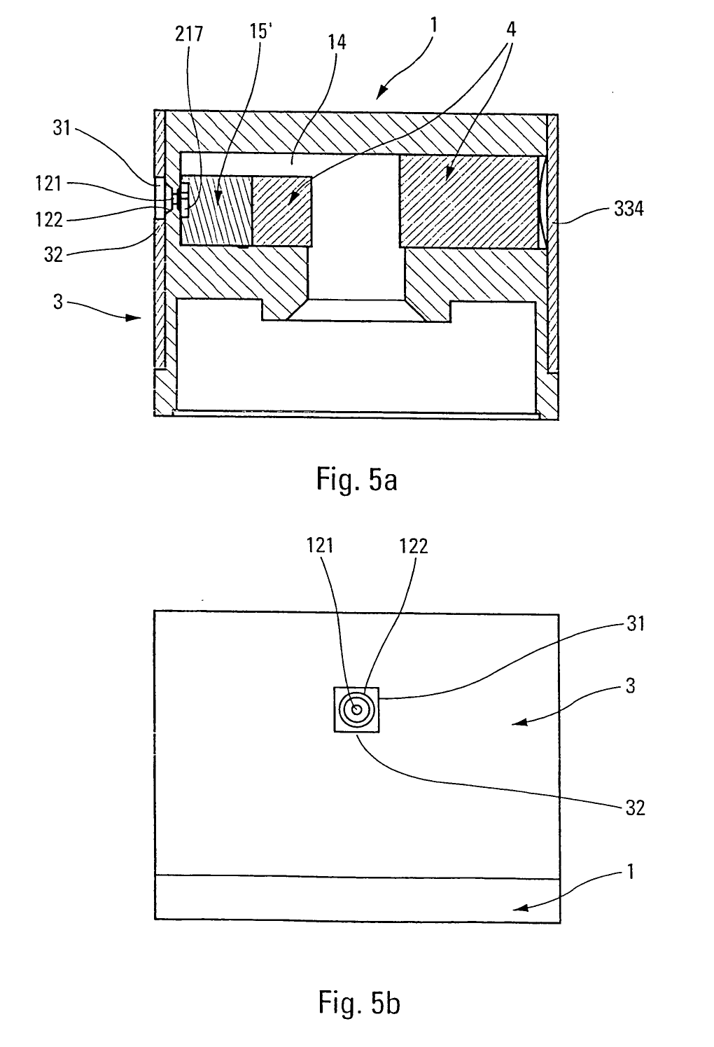

FIGS. 5a and 5b are views similar to the preceding figures for a fifth embodiment of the invention.

In all five of the embodiments shown in the figures, the dispenser head of the invention is in the form of a pusher designed to be mounted on the top end of an actuating rod of a pump or of a valve. In order to connect the pusher to the actuating rod, the pusher has a body 1 which forms a connection sleeve 12 into which the top end of an actuating rod can be force-fitted. The sleeve 12 is surrounded by a skirt 11 that masks the actuating rod.

In addition, in all of the embodiments of the figures, the pusher defines a dispensing orifice through which the fluid dispensed by the valve or delivered by the pump is discharged to the outside. In order to bring the fluid to the dispensing orifice, the pump or valve actuating rod must incorporate an internal delivery duct through which the fluid from the pump or the valve is delivered. Therefore, the fluid coming from the pump or the valve reaches the pusher just above the connection sleeve 12. At that place, the body 1 forms an outlet duct 14 which communicates downstream with the dispensing orifice which opens out at the skirt 11. Use of such a pusher in combination with a pump or a valve is very simple: by pressing on the top surface 13 of the body 1 of the pusher, which defines a pressable surface for being pressed by a finger of one hand, the pusher pushes in the actuating rod of the pump or of the valve, thereby causing a dose of fluid to be delivered through the pusher to the dispensing orifice. As soon as the pressure on the pusher is released, the pump or the valve closes again, and dispensing is finished. This mode of operation is common to all five embodiments shown in the figures.

However, without going beyond the ambit of the invention, it can be imagined that the dispenser head is not incorporated into a pusher serving to actuate the pump or the valve. Types of pumps or valves exist in which the dispensing orifice is an orifice that is fixed relative to the body of the pump or of the valve. In which case, the pusher is totally separate from the dispenser head and serves only to actuate the pump or the valve. In which case, the dispenser head can be directly incorporated into the body of the pump or of the valve, or can form a separate piece mounted in fixed manner to the body of the pump or of the valve, or else to a fixing ring for fixing the pump or the valve. Therefore, the present invention is not limited to a pusher that incorporates the dispensing orifice. However, since that type of pusher is the one that is in most widespread use in the fields of cosmetics, perfumes, and pharmaceuticals, all five embodiments in the figures relate to a conventional pusher incorporating the dispensing orifice.

In the embodiments shown in FIGS. 1a to 4b, in addition to defining the skirt 11, the connection sleeve 12, and the outlet channel 14, the body 1 of the pusher defines a core 15 which is surrounded by an annular recess 16 which communicates with the outlet duct 14. The recess 16 is formed in the skirt 11. The core 15 defines an end surface in which swirl channels and a swirl chamber 17 are provided.

The pusher also includes a dispenser element 2 which forms the dispensing orifice 21 at a free front surface 22 which is visible because it is situated on the outside of the pusher. The dispenser element 2 also forms a fixing bushing 23 which is force-engaged in the annular recess 16 formed around the core 15. In order to ensure that the dispensing element is held more securely in the recess 16, the fixing bushing 23 can be provided with fastening or barb-forming teeth suitable for biting into the inside wall 161 of the recess 16. The dispenser element 2 is engaged into the recess 16 until the inside face of the wall defining the dispensing orifice 21 comes into leaktight pressed contact against the end surface of the core 15 in which the swirl channels and the swirl chamber 17 are provided. Therefore, the inside face of the dispenser element comes to isolate the swirl channels and to complete the swirl chamber while placing the dispensing orifice 21 exactly in the center of the swirl chamber 17. The swirl channels (not shown) communicate directly with the outlet duct 14, so that the fluid delivered by the pump or the valve reaches the dispensing orifice 21 through the outlet duct 14, the recess 16, the swirl channels, and the swirl chamber 17.

This is an entirely conventional design for a pusher designed to be mounted on the hollow actuating rod of a pump or of a valve.

The free front surface 22 of the dispenser element 2 that surrounds the dispensing orifice 21 can be entirely plane, or else it can have a shaped profile as in the embodiments shown in FIGS. 1, 2, and 3. In which case, the free front surface 22 forms a diffusion cone which facilitates and guides the stream of sprayed fluid, when the dispenser is a sprayable fluid dispenser. The free front surface can also be entirely plane as in the embodiment shown in FIG. 4.

In the invention, the free front surface 22 of the dispenser element 2 is masked or covered in part by trim 3 which is provided with an opening 31 through which the free front surface 22 and the dispensing orifice are visible. The outlet 32 of the opening 31 can have the widest possible variety of shapes so that it can impart an attractive appearance to the opening 31, and thus to the pusher as a whole. The trim 3 is provided with means for fixing to the dispenser head, which means depend on the shape of the dispenser element 2 and on how it is disposed relative to the body 1.

In the first embodiment shown in FIGS. 1a and 1b, although the dispenser element 2 is engaged in the recess 16 by means of the fixing bushing 23, its front surface 22 projects outwards and forwards relative to the body 1, and more particularly relative to its outer cylindrical skirt 11. Therefore, the free front surface 22 is surrounded by a substantially cylindrical peripheral surface 24 which extends in alignment with the fixing bushing 23. In which case, the trim 3 can form a fixing rim 331 serving to come into engagement with the peripheral surface 24 of the dispenser element 2. The trim can thus be held in place on the dispenser element merely by force-engagement. It should be noted that putting the trim in place does not require any modification to be made to the pusher.

With reference to FIG. 1b, it can be seen that the outline 32 of the opening 31 is square in shape, and that the front surface 22 and the orifice 21 can be seen through said opening 31. Admittedly, the square opening is not very attractive in appearance, but it is easy to understand that it is very easy to form the opening 31 with an outline 32 that is very attractive. The same applies to the outside outline of the trim 3, which can have an attractive shape. In addition, the trim 3 masks the join of the dispenser element 2 in the recess 16 in the body 1. Therefore, it is not necessary for the recess 16 and/or the dispenser element to be finished with attractiveness that is entirely satisfactory.

In the embodiment shown in FIGS. 2a and 2b, the core 15 of the body 1 is situated a little further into the recess 16 than in the first embodiment. The dispensing element 2 is also force-engaged in the recess 16 with the fixing bushing 23 of the dispenser element 2 in engagement with the inside wall 161 of the recess 16. Since the recess 16 is deeper, because of the small size of the core 15, the free front surface 22 of the dispenser element 2 is situated inside the recess 16. In which case, the trim 3 can be inserted into the recess 16 and held in place against the free front surface 22. For this purpose, the trim 3 is in the form of a disk or of a ring provided at its center with a through opening 31 having an outline 32 that is square in shape, as can be seen in FIG. 2b. The outer peripheral edge 332 of the disk comes into engagement with the inside wall 161 of the recess 16. In this embodiment too, the trim 3 is very simple to put in place because it merely needs to be fitted into the recess 16, and it is not necessary to modify the pusher in order to receive the trim 3.

In the third embodiment shown in FIGS. 3a and 3b, the dispenser element 2 is also force-engaged in the recess 16 formed around the core 15 defining the swirl channels and the swirl chamber 17. However, an annular groove is defined around the dispenser element 2. The fixing bushing 23 of the dispenser element 2 is force-engaged in the recess 16, but the front portion of the bushing 23 is situated in a groove 17 which defines a peripheral annular gap. In which case, the trim 3 is also provided with a fixing bushing 333 which is force-engaged in the annular groove 17 so as to come into engagement both with the fixing bushing 23 and with the is inside wall of said groove 17. In this embodiment too, the opening 31 has a square outline 32 through which the free front surface 22 and the dispensing orifice 21 are visible. The trim 3 is also very simple to put in place, and does not require any modification to the pusher.

In the fourth embodiment shown in FIGS. 4a and 4b, the dispensing element 2 is also force-engaged in the recess 16 and is held in place by means of its fixing bushing 23. The dispensing orifice 21 of the dispenser element 2 is centered on the swirl chamber 17 formed in the core 15. The trim 3 is also provided with an opening 31 edged by a square opening 32 as can be seen in FIG. 4b. For fixing the trim 3 to the body 1, the trim 3 is in the form of a cylindrical sleeve 334 which is fitted over the peripheral skirt 11 of the body 1. The final position of the sleeve 334 is reached when its bottom end comes into abutment against a shoulder 110 formed by the skirt 11. In this case, the trim 3 trims not only the free front face of the dispenser element 2, but also the body 1. Because of its very simple design (cylindrical sleeve), it is very easy and inexpensive to decorate the trim over its entire cylindrical periphery. It is thus possible to impart a particular style to any pusher 1.

In the fifth embodiment of the invention shown in FIGS. 5a and 5b, the dispensing orifice and the free front surface are formed directly by the body 1, rather than by a separate dispenser element. The core 15′ defining the swirl channels and the swirl chamber 217 is formed by a separate piece inserted in a blind recess which opens out to the rear of the body 1 in a manner diametrically opposite from the dispensing orifice 121. The core 15′ is held in position by a stopper 4 which closes off the recess. The recess further forms the outlet duct 14 which communicates with the dispensing orifice 121. This is a particular embodiment in which the dispensing orifice 121 is formed directly by the body 1. Apart from this particularity related to the inside design of the pusher, the trim 3 can be strictly identical to the trim of FIGS. 4a and 4b, i.e. forming a cylindrical sleeve 334 provided with an opening 31 and engaged by being fitted over the body 1 so as to trim it almost in full. In addition, it should be noted that the trim 3 masks the stopper 4 at the opening in the recess. In this embodiment too, the trim 3 can be put in place without modifying the pusher.

By means of this trim, which can be added to a conventional dispenser head without requiring any modification, it is possible to impart a particular style to the region surrounding the dispensing orifice, and even to the entire dispenser head.

1. A dispenser head for a fluid dispenser, the dispenser head being provided with a dispensing orifice (21; 121) which opens out to the outside at a free front surface (22; 122);
said dispenser head being characterized in that it is further provided with trim (3) which extends over a portion of the free front surface and which is provided with fixing means (331; 332; 333; 334) for fixing it to the head.

2. A dispenser head according to claim 1, comprising:
a body (1) forming a fluid outlet duct (14) opening out into a recess (16); and
a dispenser element (2) forming the dispensing orifice (21) and disposed in the recess (16) in the body (1) so that the outlet duct (14) communicates with the dispensing orifice (21).

3. A dispenser head according to claim 2, in which the dispenser element (2) projects from the recess (16) so that its free front surface (22) is offset forwards relative to the body, the fixing means (331) for fixing the trim (3) co-operating with a peripheral surface (24) of the dispenser element (2), which surface extends around the free front surface (22).

4. A dispenser head according to claim 2, in which the dispenser element (2) is pushed into the recess (16) so that its free front surface (22) is situated inside the recess, the fixing means (3:32) for fixing the trim cooperating with an inside wall (161) of the recess (16).

5. A dispenser head according to claim 2, in which an annular groove (17) is defined between the dispenser element (2) and an inside wall of the recess (16), the fixing means (333) of the trim being inserted into said groove (17).

6. A dispenser head according to claim 2, in which the fixing means (334) for fixing the trim extend around the body (1).

7. A dispenser head according to claim 2, comprising a body (1), the dispenser element being formed in one piece with said body.

8. A dispenser head according to claim 1, comprising a body (1) forming the dispensing orifice (121), said trim (3) extending around said body at least in part.

9. A dispenser head according to claim 1, in which the trim remains out of contact with the fluid dispensed through the dispensing orifice.

10. A dispenser head according to claim 1, in which the trim extends around the dispensing orifice at least in part.
